(19) United States
(12) Patent Application Publication
(10) Pub. No.: US 2008/0114979 A1
(43) Pub. Date: May 15, 2008

(54) METHOD FOR PROCESSING WORKING STATE OF PROCESSING DEVICE BY USING IDENTIFICATION DATA

(76) Inventor: Chen-Ning Hsi, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/739,681

(22) Filed: Apr. 24, 2007

(30) Foreign Application Priority Data
Nov. 15, 2006 (TW) 095142183

(51) Int. Cl. H04L 9/00

(52) U.S. Cl. 713/161

(57) ABSTRACT

A method for processing a working state of a first processing device is disclosed. The method includes: providing a configuration setting record; selectively recording a device operation state and at least an application execution state in the working state as a state data of the first processing device according to the configuration setting record; and storing the state data.

### BACKGROUND OF THE INVENTION

1. Field of the Invention

The present invention relates to a scheme for processing a working state, and more particularly, to a method capable of loading a working state of a different processing device by utilizing an identification data and a state data.

2. Description of the Prior Art

Generally speaking, with regards to completing a task, there are various circumstances in which a user terminates an operation of a processing device at place A and then goes to place B to perform an operation of another processing device for continuing the same task (For example, the user may shut down a company computer when leaving work and then go to his/her home to use a home computer for continuing his/her unfinished task). When this happens, the user may wish to continue his/her task directly from place B instead of first setting a working state of the processing device at place B for that of the processing device at place A. This is because users are unlikely to change their habits during such a short time period, and there is also unlikely to be change in a favorite setting of a processing device, an operating process, or programs opened by the user when performing the same task. Therefore, if the user needs to reset a working state of a processing device at another place every time he/she changes location, it will be a redundant operation for the user to reset the working state. The user may even need to further record steps of resetting the working state to avoid him/her being unable to continue the task if a related setting for continuing the task is very complicated.

### SUMMARY OF THE INVENTION

It is therefore one of the objectives of the present invention to provide a method for processing (storing or loading) a working state of a processing device, to solve the above-mentioned problems.

According to an embodiment of the claimed invention, a method for processing a working state of a first processing device is disclosed. The method comprises: providing a configuration setting record; selectively recording a device operation state and at least an application execution state in the working state as a state data of the first processing device according to the configuration setting record; and storing the state data.

According to an embodiment of the claimed invention, a method for processing a working state of a first processing device is disclosed. The method comprises: recording the working state as a state data of the first processing device and generating an identification data according to the state data; and storing the state data and the identification data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a system according to an embodiment of the present invention.

FIG. 2 is a flowchart illustrating an operation of the system shown in FIG. 1.

### DETAILED DESCRIPTION

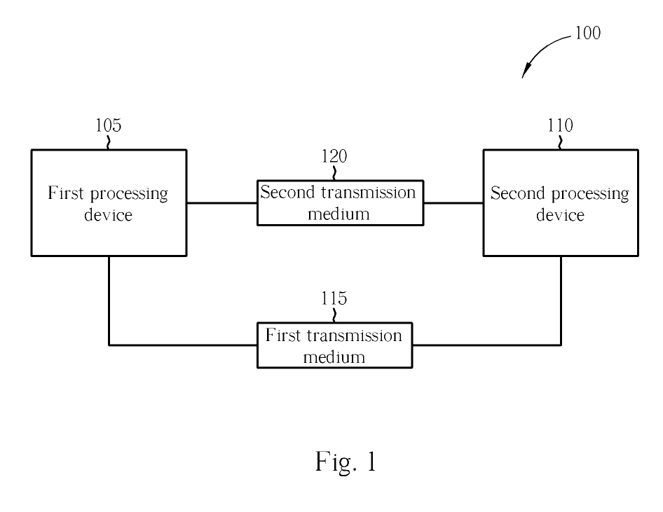

Please refer to FIG. 1. FIG. 1 is a diagram of a system 100 according to an embodiment of the present invention. As shown in FIG. 1, the system 100 comprises a first processing device 105, a second processing device 110, a first transmission medium 115, and a second transmission medium 120, where the first processing device 105 and second processing device 110 are computer systems. The first transmission medium 115 and second transmission medium 120 are used as the transmission media for respectively transmitting a state data and an identification data corresponding to a working state of the first processing device 105 to the second processing device 110. In this embodiment, the working state includes a device operation state and at least an application execution state. Taken as an example of a computer system, a fundamental state (e.g. activated or closed) of each application in the computer system is recorded in the device operation state. How the application executes is recorded in the application execution state. For an example of Email management software, whether the Email management software is activated or not is recorded in the device operation state. Once the Email management software is activated, how the Email management software operates is recorded in the application execution state. For instance, content of a specific mail currently read by a user in a mailbox or content of a mail now written by a user is recorded. Accordingly, the first processing device 105 can record its working state as a state data and then generate an identification data ID according to the state data. The state data is transmitted to the second processing device 110 via the second transmission medium 120, and the identification data is transmitted to the second processing device 110 via the first transmission medium 115. The second processing device 110 can read the state data to load the working state of the first processing device 105 according to the identification data ID.

In addition, the first processing device 105 also provides a configuration setting record so that different users can set different configuration setting records according to their habits. The configuration setting record corresponds to a plurality of applications. In other words, with respect to each of the applications, a user can set a corresponding specific storage configuration. For example, if a programming language software and the above-mentioned Email management software are included in the applications, then a user can set specific storage configurations according to his/her preference. If the user wishes to immediately proceed with a related task with respect to the programming language software in the second processing device 110 (without temporarily writing an Email), then it will be recorded in the configuration setting record of the first processing device 105 that a specific storage configuration of the programming language software is more important and a specific storage configuration of the Email management software is less important. That is, if a specific storage configuration is more important, then an application corresponding to the specific storage configuration will be more completely recorded as a detailed state data. When the working state is recorded as the state data, the state data is stored according to the above-mentioned configuration setting record such that a waste of a storage space and a longer processing time, resulting from a detailed record for states of all applications, can be avoided. For users, at this time, only some particular application execution states are required to be recorded. Therefore, the second processing device 110 can load the working state of the first processing device 105 immediately to proceed with a user's task without first performing step-by-step setting. According to the above-described configuration setting record, when a user wishes to store the working state of the first processing device 105 for proceeding with his/her task on the second processing device 110, he/she only needs to control the first processing device 105 to issue an operation command for recording the working state as a state data and generating an identification data. The first processing device 105 records the working state as the state data and then stores the identification data and the state data in the first transmission medium 115 and the second transmission medium 120 respectively. Moreover, it is also not required for the user to issue the operation command when the above-mentioned procedure can be performed automatically by automatically recording before the first processing device 105 shuts down.

In this embodiment, the first transmission medium 115 is a portable device capable of accessing the first processing device 105 and the second processing device 110. For instance, the first transmission medium 115 can be a mouse having an internal memory, a mobile phone, or a personal digital assistant (PDA), and the second transmission medium 120 can be a server on the Internet. As mentioned above, the identification data ID will be stored in the portable device and the state data will be stored into the server. Accordingly, when the user connects the portable device with the second processing device 110, the identification data ID can be retrieved from the second processing device 110. Also, the second processing device 110 can retrieve a corresponding state data from the server to load the working state of the first processing device 105 according to the identification data ID. For the user, since a data amount of the identification data ID is very small but a data amount of the state data is very large due to the detailed record of the working state, a scheme for respectively storing the identification data ID and the state data can save an occupied internal memory space utilized for storing the state data in the portable device. Additionally, in other embodiments, if the portable device has a larger memory space or the state data becomes smaller, it is also possible to use the above-mentioned server as the first transmission medium 115 and the above-mentioned portable device as the second transmission medium 120. The second processing device 110 then retrieves the state data from the portable device to load the working state of the first processing device 105 according to the identification data in the server. This modification also falls within the scope of the present invention.

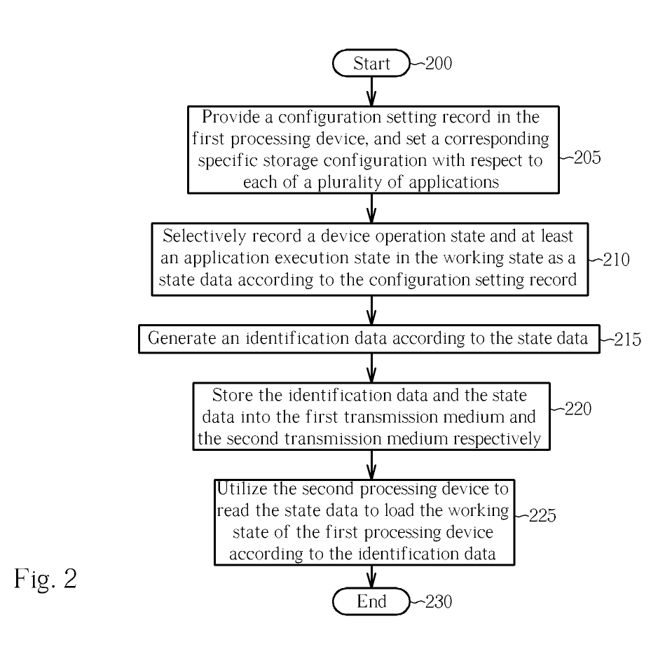

Please refer to FIG. 2. FIG. 2 is a flowchart illustrating an operation of the system 100 shown in FIG. 1. Provided that substantially the same result is achieved, the steps of the flowchart shown in FIG. 2 need not be in the exact order shown and need not be contiguous, that is, other steps can be intermediate. According to the above description, the operation of the system 100 can be illustrated as follows:

Step 200: Start.

Step 205: Provide a configuration setting record in the first processing device 105, and set a corresponding specific storage configuration with respect to each of a plurality of applications.

Step 210: Selectively record a device operation state and at least an application execution state in the working state as a state data in the first processing device 105 according to the configuration setting record.

Step 215: Generate an identification data ID according to the state data.

Step 220: Store the identification data ID and the state data into the first transmission medium 115 and the second transmission medium 120 respectively.

Step 225: Utilize the second processing device 110 to read the state data to load the working state of the first processing device 105 according to the identification data ID.

Step 230: End.

Additionally, in another embodiment, the first processing device 105 and the second processing device 110 respectively operate in heterogeneous environments. For instance, if the first processing device 105 is a windows operating system but the second processing device 110 is a non-windows operating system, it is possible that the second processing device 110 cannot load the working state of the first processing device 105 immediately according to the state data. This problem, however, can be solved by providing a mapping table to convert the working state of the first processing device 105 into a converted working state complying with an operation environment of the second processing device 110. Then, the second processing device 110 can load the converted working state to allow the user to proceed with his/her task. It should be noted that the first processing device 105 and second processing device 110 have the same file management devices, and either one of the first processing device 105 and second processing device 110 can be a mobile phone, a PDA, or an MP3 player, etc, and is not limited to be a common computer system.

Moreover, in another embodiment, the function of the configuration setting record is optional and therefore can be removed. Even without the configuration setting record, the goal of storing/loading a working state can be achieved. In other words, when recording the working state as a state data, a first processing device in this embodiment will directly record a current device operation state and application execution states corresponding to all applications as the state data, without referring to any configuration setting record. This modification is also able to solve the above-mentioned problems although the system may be busy due to unnecessary operations; this also obeys the spirit of the present invention.

Those skilled in the art will readily observe that numerous modifications and alterations of the device and method may be made while retaining the teachings of the invention.

What is claimed is:

1. A method for processing a working state of a first processing device, comprising:
(a) providing a configuration setting record;
(b) selectively recording a device operation state and at least an application execution state in the working state as a state data of the first processing device according to the configuration setting record; and
(c) storing the state data.

2. The method of claim 1, wherein the step (b) further comprises: generating an identification data according to the state data; and the step (c) further comprises: storing the identification data.

3. The method of claim 2, wherein the step (c) further comprises:
storing the state data in a first transmission medium, and storing the identification data in a second transmission medium different from the first transmission medium.

4. The method of claim 3, wherein the first transmission medium is a portable device, and the second transmission medium is a server coupled to the first processing device.

5. The method of claim 3, wherein the second transmission medium is a portable device, and the first transmission medium is a server coupled to the first processing device.

6. The method of claim 1, wherein the configuration setting record corresponds to a plurality of applications, and the step (a) further comprises:
setting a specific storage configuration for each application in the plurality of applications.

7. The method of claim 1, wherein the first processing device is a mobile phone, a personal digital assistant (PDA), or an MP3 player.

8. The method of claim 1, further comprising:
(d) utilizing a second processing device to read the state data and to load the working state of the first processing device according to the state data.

9. The method of claim 8, wherein the step (b) further comprises: generating an identification data according to the state data; the step (c) further comprises: storing the identification data; and the step (d) further comprises: utilizing the second processing device to read the state data according to the identification data.

10. The method of claim 9, wherein the step (c) further comprises: storing the state data in a first transmission medium and storing the identification data in a second transmission medium different from the first transmission medium; and the step (d) further comprises: utilizing the second processing device to retrieve the state data and the identification data from the first transmission medium and the second transmission medium respectively.

11. The method of claim 10, wherein the first transmission medium is a portable device, and the second transmission medium is a server coupled to the first processing device and the second processing device respectively.

12. The method of claim 10, wherein the second transmission medium is a portable device, and the first transmission medium is a server coupled to the first processing device and the second processing device respectively.

13. The method of claim 8, wherein the first processing device and the second processing device have the same file management devices, and one of the first processing device and the second processing device is a mobile phone, a PDA, or an MP3 player.

14. The method of claim 8, wherein the first processing device and the second processing device operate in a heterogeneous environment, and the step (d) further comprises:
providing a mapping table;
utilizing the mapping table to convert the working state of the first processing device into a converted working state complying with an operating environment of the second processing device; and
utilizing the second processing device to load the converted working state.

15. A method for processing a working state of a first processing device, comprising:
(a) recording the working state as a state data of the first processing device and generating an identification data according to the state data; and
(b) storing the state data and the identification data.

16. The method of claim 15, wherein the step (b) further comprises: storing the state data in a first transmission medium, and storing the identification data in a second transmission medium different from the first transmission medium.

17. The method of claim 16, wherein the first transmission medium is a portable device, and the second transmission medium is a server coupled to the first processing device.

18. The method of claim 16, wherein the second transmission medium is a portable device, and the first transmission medium is a server coupled to the first processing device.

19. The method of claim 15, wherein the first processing device is a mobile phone, a PDA, or a MP3 player.

20. The method of claim 15, further comprising:
(c) utilizing a second processing device to read the state data according to the identification data and to load the working state of the first processing device according to the state data.

21. The method of claim 20, wherein the step (c) further comprises: storing the state data in a first transmission medium and storing the identification data in a second transmission medium different from the first transmission medium; and the step (c) further comprises: utilizing the second processing device to retrieve the state data and the identification data from the first transmission medium and the second transmission medium respectively.

22. The method of claim 21, wherein the first transmission medium is a portable device, and the second transmission device is a server coupled to the first processing device and the second processing device respectively.

23. The method of claim 21, wherein the second transmission medium is a portable device, and the first transmission device is a server coupled to the first processing device and the second processing device respectively.

24. The method of claim 20, wherein the first processing device and the second processing device have the same file management devices, and one of the first processing device and the second processing device is a mobile phone, a PDA, or a MP3 player.

25. The method of claim 20, wherein the first processing device and the second processing device operate in a heterogeneous environment, and the step (c) further comprises:
providing a mapping table;
utilizing the mapping table to convert the working state of the first processing device into a converted working state complying with an operating environment of the second processing device; and
utilizing the second processing device to load the converted working state.
